(19) United States
(12) Patent Application Publication
(10) Pub. No.: US 2015/0142489 A1
(43) Pub. Date: May 21, 2015

(54) OPTIMIZING ONSITE VENDOR BUSINESS

(71) Applicant: Breezeworks Corporation, San Francisco, CA (US)

(72) Inventors: Adam Block, San Francisco, CA (US); Matthew Cowan, Hillsborough, CA (US)

(21) Appl. No.: 14/546,780

(22) Filed: Nov. 18, 2014

Related U.S. Application Data
(60) Provisional application No. 61/905,777, filed on Nov. 18, 2013.

(51) Int. Cl. G06Q 10/06; H04L 29/08

(52) U.S. Cl. CPC G06Q 10/06311; H04L 67/10
USPC 705/7.13

(57) ABSTRACT

Systems and methods are provided to optimize a vendor's schedule by analyzing potential follow-up tasks and suggesting suitable follow-up tasks that satisfy certain criteria. The total revenue per hour of the follow-up task may be calculated by taking travel time to and from the follow-up task into account and compared to total revenue per hour calculated based on the vendor's historical job information. Coupon rates that may be offered to the customer associated with the follow-up task may also be determined algorithmically and suggested to the vendor.

### CROSS-REFERENCES TO RELATED APPLICATIONS

The present application claims priority from and is a non-provisional application of U.S. Provisional Application No. 61/905,777, entitled “Systems And Methods For Optimizing Onsite Vendor Business” filed Nov. 18, 2013, the entire contents of which are herein incorporated by reference for all purposes.

### FIELD

The present disclosure describes systems and methods for optimizing onsite vendor business, and more particularly to identifying follow-up tasks that satisfy criteria for scheduling, and potentially other criteria.

### BACKGROUND

Onsite vendors (e.g. electricians, plumbers, locksmiths, etc.) share similar business challenges, despite the diversity of their trades. For these vendors, it can be difficult to manage and optimize the business. Onsite vendors may be overworked and short on time—the time and energy spent traveling between jobs and fulfilling appointments can easily make the creation of appointments and planning of an optimal schedule to be an impossible or very undesirable task. Scheduling is a complicated task that, to be done efficiently, requires many factors to be taken into consideration. Careless scheduling can result in open blocks of time and longer drives than necessary.

Another problem that plagues vendors is customer no-shows. Further, vendors often lack the resources to mitigate their losses from no-shows by quickly filling unplanned openings in a schedule. Vendors generally lack the software tools to conveniently track and leverage the information related to their time, jobs, and customer information. And, customers often forget to have repairs or routine maintenance done, or are simply unaware of manufacturers' maintenance schedules on home or office equipment, which can end up costing customers more money in the long run.

Therefore, it is desirable to provide new systems and methods of addressing such technical problems encountered in automatic scheduling of jobs and other problems.

### BRIEF SUMMARY

Embodiments of the present invention provide methods and systems for providing a schedule for a vendor. For example, a schedule may be provided by identifying potential follow-up tasks associated with completed jobs by the vendor by accessing a follow-up table. The follow-up tasks may be determined based on certain data, including the total revenue per hour of the vendor, the location of the follow-up task, the estimated duration of the follow-up task, the estimated travel time to and from the follow-up task, and other information. Accordingly, some follow-up tasks may be determined to contribute to a more optimized schedule than other follow-up tasks. An optimized list of potential follow-up tasks can be provided to a user (also called vendor). The vendor may weigh the follow-up task options that are provided to them and choose whether they would like to add any of the follow-up tasks to their schedule and/or whether to contact customers to set appointments as part of such optimal schedules.

In some embodiments, when a vendor decides to schedule a particular follow-up task, potential discount rates for offering to the customer can be suggested to the vendor. For example, a discount rate may be determined by first comparing the vendor's total average revenue per hour and the estimated revenue per hour provided by the follow-up task. If the estimated revenue per hour provided by the follow-up task is greater than the vendor's average total revenue per hour by a threshold, then one or more discounts may be suggested. In some cases, the suggested discount rates may correspond to the percentage that the estimated revenue per hour provided by the follow-up may be decreased and still be greater than the vendor's total average revenue per hour. Thus, certain discount rates applied to the follow-up task may still provide an increase for the vendor. The vendor may weigh the discount options and determine whether a certain discount should be offered when scheduling an appointment for a follow-up task with a customer. A difference in revenue rate can be provided before and after the discount.

Other embodiments are directed to systems, portable consumer devices, and computer readable media associated with methods described herein.

A better understanding of the nature and advantages of embodiments of the present invention may be gained with reference to the following detailed description and the accompanying drawings.

### BRIEF DESCRIPTION OF THE DRAWINGS

FIG. 1 shows a block diagram of various subsystems according to embodiments of the present invention.

FIG. 2 shows a block diagram of the mobile application modules according to embodiments of the present invention.

FIG. 3 shows a block diagram of the data store according to embodiments of the present invention.

FIG. 4 shows an exemplary display of a schedule being provided to the vendor according to embodiments of the present invention.

FIG. 5 shows an exemplary display of a completed job along with a suggestion for a follow-up task being provided to the vendor according to embodiments of the present invention.

FIG. 6 shows a follow-up table that may contain a list of follow-up task opportunities according to embodiments of the present invention.

FIG. 7 shows an exemplary suitable follow-up position relative to an anchor position according to embodiments of the present invention.

FIG. 8 contains a flowchart illustrating a method according to embodiments of the present invention.

FIG. 9 contains an exemplary display showing a follow up notification containing discount rate suggestions sent to the Vendor according to embodiments of the present invention.

FIG. 10 shows a flowchart comprising the process 1000 taken to suggest a follow-up task and associated coupon discount rates to a vendor according to embodiments of the present invention.

FIG. 11 shows a block diagram of an example computer system 1100 usable with system and methods according to embodiments of the present invention.

### DETAILED DESCRIPTION

The present disclosure relates to systems and methods for optimizing onsite vendor business. Embodiments may comprise systems and methods of employing active and passive data collection and analysis to assist onsite vendors with scheduling of appointments and routes. For example, examples computer systems can identify follow-up tasks, determine suitable times to schedule an appointment based on a variety of factors, and potentially determine suitable incentives to a customer to increase the probability of having an appointment at a desirable time. Components that may be used in certain embodiments are described in more detail below.

### I. System

### A. Example Architecture

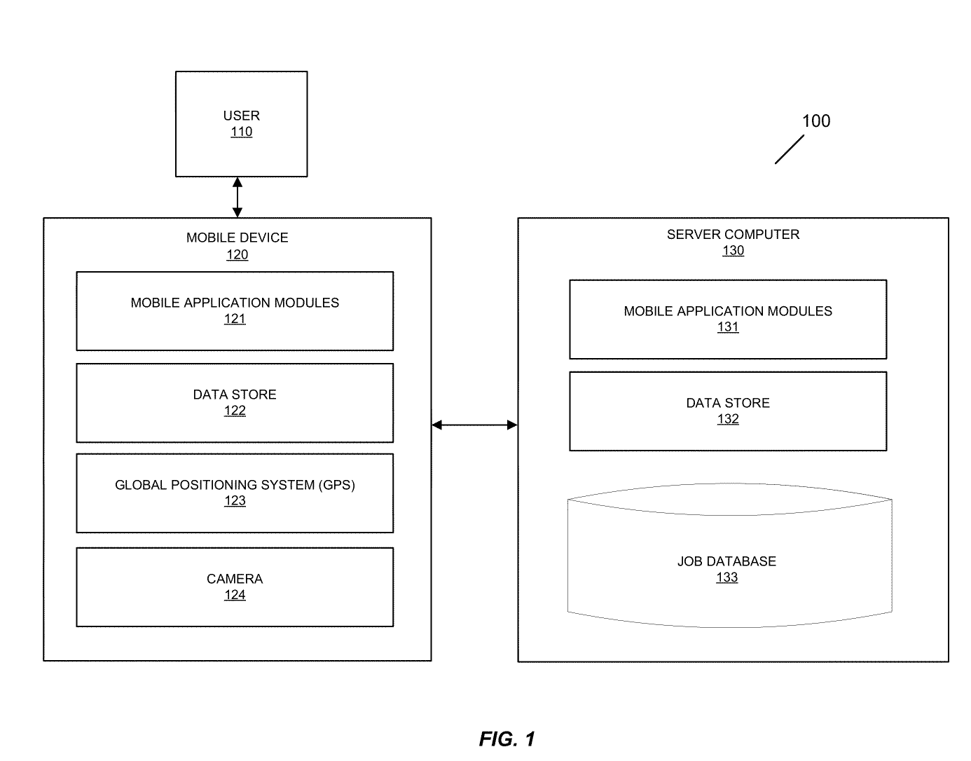

FIG. 1 shows a block diagram of various subsystems according to embodiments of the present invention. The system 100 may comprise a user 110, a mobile device 120, and server computer 130. The user 110 may be a vendor that may utilize their mobile device 120 to maintain a schedule of job appointments. The user 110 may be an onsite vendor (e.g. electricians, plumbers, locksmiths, etc.) that may need to spend substantial time traveling between various job locations for jobs that may take varied time durations to complete. As examples, the user may be a sole proprietor or a part of a partnership or small business.

The mobile device 120 may be any suitable device that may install a mobile application, have wireless communication capability, and have the ability to carry out functions described herein. The mobile device 120 may be associated with the user 110 and may comprise mobile application modules 121, a data store 122, a global positioning system (GPS) 123 and a camera 124.

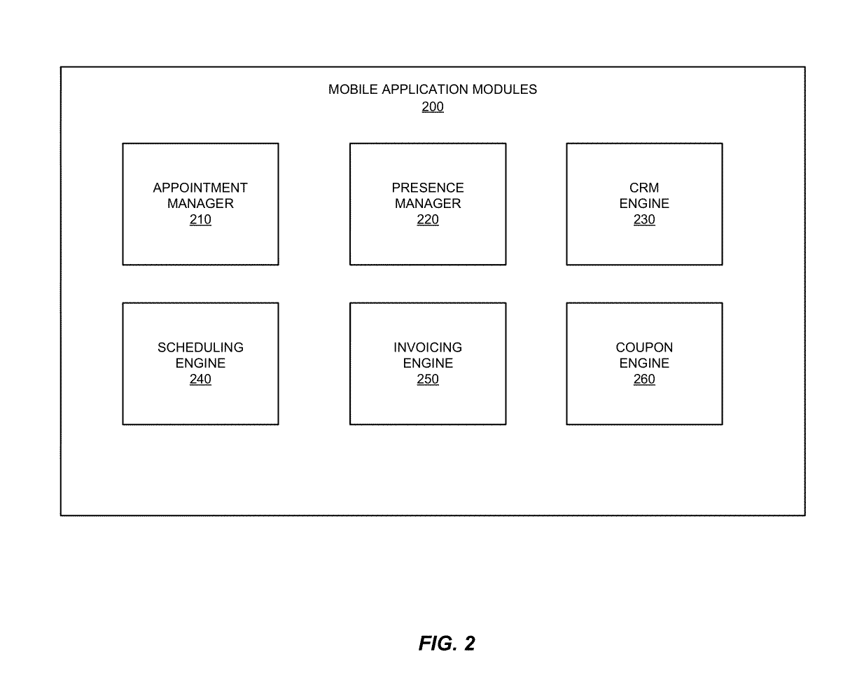

The mobile application modules 121 may utilize pertinent information gathered by the mobile device 120 and the vendor to carry out functions, which may be performed in conjunction with server computer 130. For example, the application modules may help determine when to schedule appointments, track the vendor's location, maintain customer relations, store information about the vendor's schedule, create invoices associated with completed jobs, and calculate potential discount rates. FIG. 2 describes the mobile application modules in more detail.

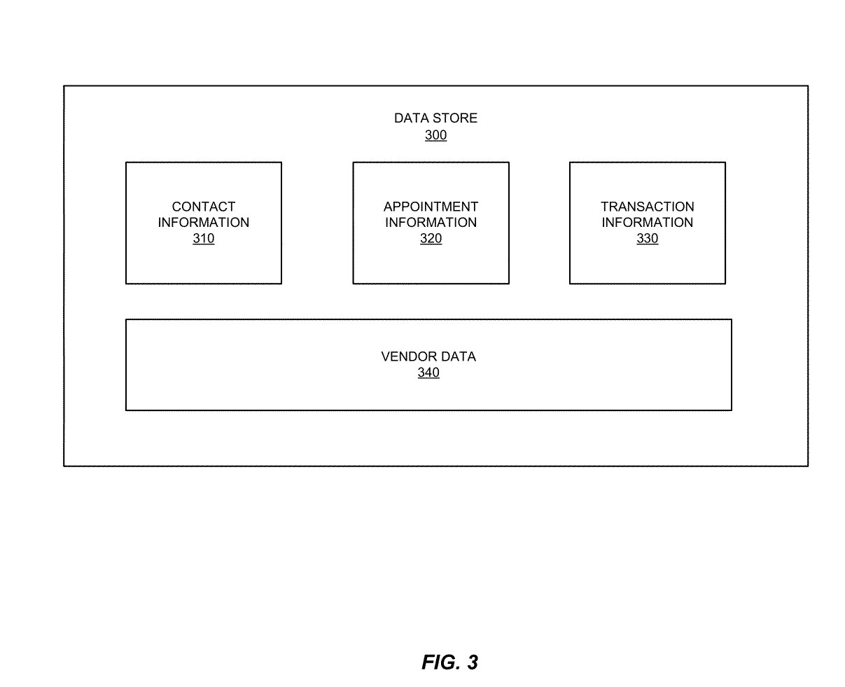

The data store 122 may contain a record of information associated with the vendor's schedule. The data store 122 may comprise the contact information of customers, the appointment and transaction information associated with jobs scheduled for a vendor, and other vendor data that may be useful to maintain about the vendor's schedule. FIG. 3 describes the data store in more detail.

The GPS 123 may comprise any suitable location tracking sensor that may track the location of mobile device 120 and hence the vendor's location. The GPS 123 may track the location of the vendor in real time in order to determine whether a vendor should be alerted to leave for their next appointment. Additionally, embodiments may store the location information tracked by the GPS 123 in order to use the information for time audits, business optimization analytics, or other purposes. The camera 124 may be any suitable hardware that may capture an image that may be saved onto the mobile device 120.

The server computer 130 may maintain a multi-tenant database that may store and manage all information associated with multiple vendors. Each vendor may be a separate tenant in the database. For ease of explanation, further discussions will generally be limited to one vendor, but similar operations can be performed for each vendor and other tables can be multi-tenant tables. The server computer 130 may be in communication with the mobile device 120 and may comprise mobile application modules 131, a data store 132, and a job database 133. The functions of the mobile application modules 131 and data store 132 may be analogous to the mobile application modules 121 and data store 122 residing in the mobile device 120.

Since the application modules and datastore may run in the mobile device 120 and the server computer 130, synchronization of the two separate datastores can be performed to provide current information to the application modules. When data is entered by user 110 into the mobile device 120, the data may be stored into the data store 122 of the mobile device 120 and synchronized to the data store 132 of the server computer 130. If the user 110 enters any information when there is a loss of connectivity between the mobile device 120 and the server computer 130, the entered information may be immediately synchronized to the server computer 130 upon restoration of connectivity.

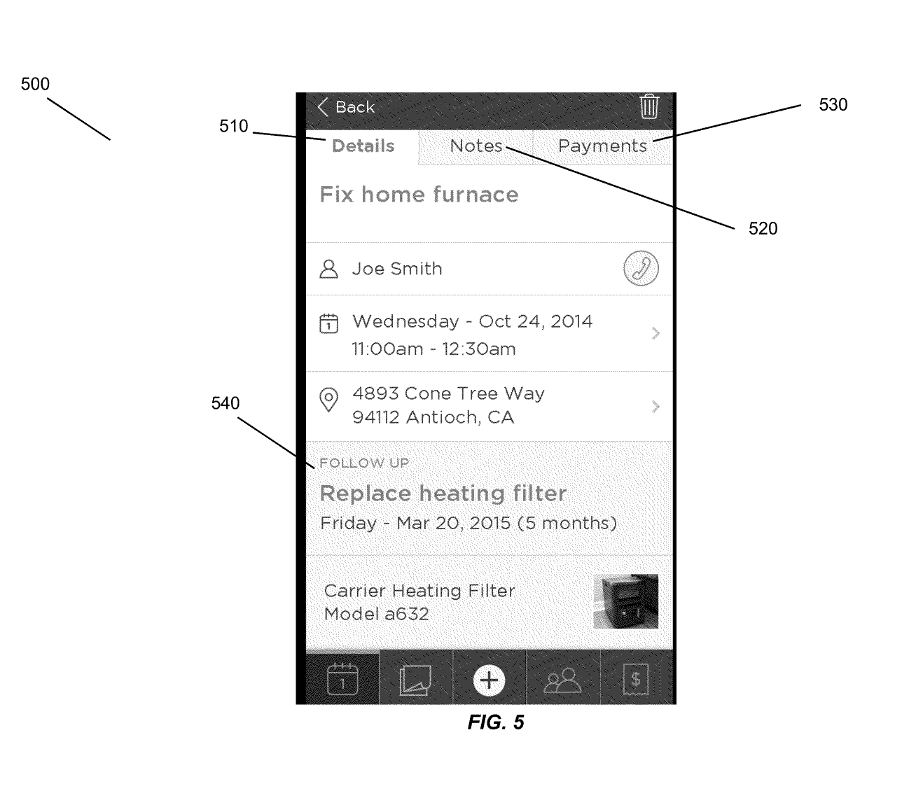

The job database 133 may contain any information related to potential follow-up tasks that may be associated with jobs already completed by a vendor. For a particular vendor, the job database 133 may contain a record for each customer or job in a main table, and the vendor may be associated with a specific follow-up table or with a section of a multi-tenant follow-up table. Each job record may be associated with one or more entries in the follow-up table. The follow-up table may contain information such as the customer name, the service address, a description of the follow-up task, the estimated charge of the follow-up task, the targeted service due date, and the completed job that the follow-up task may be associated with. The follow-up table can also include an ID that identifies the follow-up task, where the ID can act as a foreign key in a main table for accessing the child table (i.e., the follow-up table). FIG. 5 describes the structure of the follow-up table in more detail.

FIG. 2 shows a block diagram of the mobile application modules according to embodiments of the present invention. The mobile application modules 200 may comprise an appointment manager 210, a presence manager 220, a customer relationship management (CRM) engine 230, a scheduling engine 240, an invoicing engine 250, and a coupon engine 260.

The appointment manager 210 may comprise the application logic used in scheduling new appointments or moving existing appointment in a vendor's schedule. The appointment manager 210 may be responsible for maintaining the appointments residing in the vendor's schedule.

The presence manager 220 may track the vendor's location information in real time using the GPS 123 as well as maintain historical location information about the vendor. The real-time location information accessed by the presence manager 220 may enable intelligent alerts to the vendor notifying when to leave a current job in order to be on time to a subsequent appointment. Further, the historical location information stored by the presence manager 220 may be used for time audits, business optimization analytics, or other purposes.

The CRM engine 230 may manage the vendor's interactions with customers in various ways. For instance, the CRM engine 230 may implement a forecasting model to determine future job opportunities associated with certain customers for the vendor. Additionally, the CRM engine 230 may help the vendor analyze a customer's sales history and market various job opportunities to them accordingly.

The scheduling engine 240 may comprise the vendor's schedule. The scheduling engine 240 may contain any information that may be used to a customer or job appointment in the vendor's schedule.

The invoicing engine 250 may create an invoice after the vendor completes a job, which subsequently moves to a billable state. The invoice can be created using contextual data related to the job (e.g., the vendor was at the location of the job for 2 hours, so 2 hours can be auto-filled into the invoice or can be included in a prompt to the vendor for confirmation before being inserted into the invoice). The vendor can adjust hourly rates at any time and data may also be entered into the invoice manually. The invoicing engine 250 can reduce the amount of time it takes to generate a new invoice by seamlessly pre-populating as much of the data as possible, such as the customer name, address, job description, and any other information. Invoice templates can also be utilized with vendor logos, license numbers and business names.

After the invoice is created, the invoice may be sent to the customer for immediate or future payment. Some embodiments enable on-the-spot payment collection, which can allow processing of check payments using mobile image check capture technology, credit card payments, remote payments via cell phone, and other payment methods; accepted payment methods are universal across vendors. If an invoice is sent to a customer for future payment, the status of the invoice and other outstanding invoices may be monitored, so that vendors may follow up with customers to retrieve payment.

The coupon engine 260 may generate coupons based on coupon discount rate suggestions. For a given follow-up offer to a customer, the coupon engine 260 may generate multiple coupons with different discount rates in order to allow the customer to choose amongst options that may result in a profitable follow-up task. In some cases, the vendor may manually enter the desired discount rate to offer to the customer, after which the coupon engine 260 may then generate a coupon corresponding to the manually entered discount rate.

FIG. 3 shows a block diagram of the data store according to embodiments of the present invention. The data store 300 may contain contact information 310, appointment information 320, transaction information 330, and vendor data 340.

The contact information 310 may comprise information identifying customers. The contact information 310 may be entered manually by the vendor and may be stored for later reference when the vendor wants to schedule an appointment with the customer.

The appointment information 320 may comprise the information surrounding the appointments in the vendor's schedule. For example, the appointment information 320 may comprise the date, time, service address, and other information associated with a job appointment.

The transaction information 330 may comprise the information regarding any financial exchanges that the vendor has handled relating to the jobs on the vendor's schedule. For example, the transaction information 330 may contain information captured from invoices created after jobs have been completed. The vendor data 340 may comprise any information relating to vendor identification or historical data that may be utilized to analyze the vendor's schedule.

### B. Input and Storage of Data for Customer and Job

Customers who discover a vendor (e.g., through word-of-mouth, advertising, partner sites that display vendors, or other channels) can contact the vendor and give the contact information, such as a service address. In some embodiments, a record of this communication (e.g. text, email, phone call transcript etc.) may be saved for the vendor and/or customer to access later. Accordingly, the customer data may be stored into the vendor's mobile device and synchronized to the remote database.

If the customer wants to schedule a job appointment with the vendor, the customer may contact the vendor. Upon scheduling the job, the vendor may input information surrounding the job into the customer's record stored by the job database. The information may include the job type, the service date, the estimated charge, and other information. Some of this information may not be inputted by the vendor, but automatically populated instead. Intelligent searches and references to historical or industry standard information may be utilized to determine some information fields, such as estimated charge of the job. The vendor may choose to override any information manually at any time.

The job database 133 may comprise a main table comprising all customer and job information corresponding to multiple vendors. For each vendor, the main table may contain a record for each customer and job. Further, each vendor may be associated with a follow-up table containing information relating to follow-up tasks associated with jobs completed by the vendor.

### C. Schedule

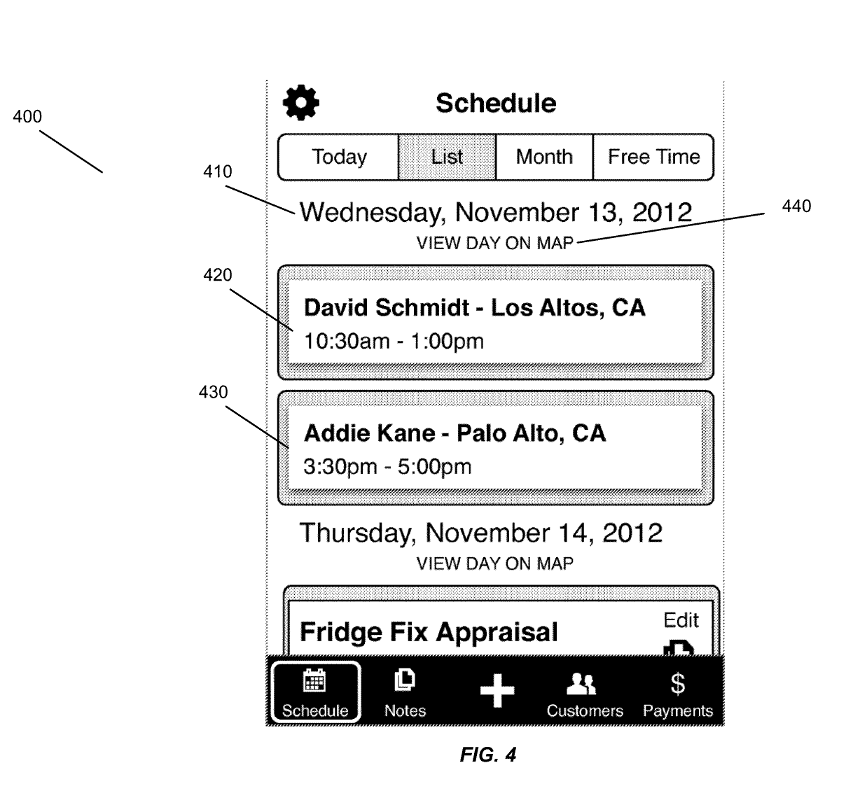

FIG. 4 shows an exemplary display of a schedule being provided to the vendor according to embodiments of the present invention. The schedule 400 may provide the vendor with a summary of job appointments in the vendor's schedule for a certain day, week, or month. The schedule 400 may include the date of service 410, a first appointment 420, a second appointment 430, and map view option 440.

The date of service 410 indicates the day that certain appointments are scheduled in the vendor's schedule. Each job appointment listed under the date of service 410 is associated with the corresponding date. For example, the vendor may look at their schedule corresponding to date “Wednesday, Nov. 13, 2012” to see all appointments scheduled on Nov. 13, 2012. The records in the job database corresponding to the first appointment 420 and second appointment 430 will contain the service date of “Wednesday, Nov. 13, 2012.”

The first appointment 420 and second appointment 430 are exemplary job appointments scheduled on the same day in the vendor's schedule. The appointments may be ordered chronologically so that the first appointment 420, which starts at 10:30 AM, may be listed before the second appointment 430, which starts at 3:30 PM. For each appointment, information, such as the customer name and job location, may be displayed to the vendor. For instance, the first appointment 420 corresponds to customer “David Schmidt” who scheduled a job in “Los Altos, Calif.” and the second appointment 430 corresponds to customer “Addie Kane” who scheduled a job in “Palo Alto, Calif.” The vendor may view further information about the customer or job by clicking on the displayed appointment, which can display a page containing information stored in the corresponding record in the job database. For instance, the vendor may want to learn more about the information related to the first appointment 420 and click on it. A page may be displayed containing the job type, estimated charge, a list of tools needed, and any other information associated with the first appointment 420. Further, the page may display contact information and historical appointments of David Schmidt. The vendor may choose to override any information associated with a job appointment for any reason.

The map view option 440 can allow the vendor to view the job appointments scheduled for a certain day geographically. For example, the vendor may click on the map view option 440 to see the locations of the first appointment 420 and the second appointment 430 displayed on a map. In some embodiments, the vendor may also view various routes that can be taken to get from the first appointment 420 to the second appointment 430, as well as anticipated travel time on the map.

### D. Identification of Follow-up

Daily or multiple times a day, the time between existing appointments may be utilized to determine suitable follow-up tasks that may be suggested to be added into the vendor's schedule. Follow-up tasks can stem from the existing appointments in the vendor's schedule.

A follow-up notification may be sent to a vendor containing information about a follow-up task associated with a completed job. In other words, a follow-up notification may be a suggestion to the vendor to make a future appointment for a follow-up task with a customer that they have already worked for. Accordingly, the vendor may consider the information provided in the follow-up notification and determine whether they want to add the follow-up task into their schedule.

At the conclusion of each job, embodiments can prompt the vendor via mobile device to specify one or more follow-up task opportunities. If the vendor knows that a follow-up task should be scheduled, the vendor may input information pertaining to a follow-up task upon completing the associated job. For example, after completing a job for a customer, the vendor may know that the customer will need a new furnace filter in six months. The vendor can enter this information through the mobile device and embodiments will store the information in the job database. Since the job the vendor has just completed is already known due to the creation of the invoice, information associated with the follow-up task can be automatically associated with the completed job.

FIG. 5 shows an exemplary display of a completed job along with a suggestion for a follow-up task being provided to the vendor according to embodiments of the present invention. The appointment 500 corresponds to a job on the vendor's schedule and may include the appointment details 510, appointment notes 520, appointment payments 530, and follow-up information 540.

The appointment details 510 may include any information surrounding the job that may help identify the appointment. The appointment details may contain a job type (“Fix home furnace”), the Customer name (“Joe Smith”), the appointment date (“Wednesday—Oct. 24, 2014”), and the appointment address (“4893 Cone Tree Way; 94112 Antioch, CA”).

The appointment notes 520 may include any information associated with the job that may be logged. Data can be collected by active and passive logging. Passive logging may be performed by examining certain data parameters. For instance, location data can be analyzed to log what time the vendor arrived for a job, how long it took the vendor to park, and how many hours the vendor spent at the job. Active logging may also be performed; for example, vendors can log job notes, photos, recordings, and videos using a mobile device, and associate them with their jobs and accumulate them in the appointment notes 520. In some embodiments, these records can be geocoded, time scanned, backed up, and forwarded to customers. Embodiments allow the ability to assist vendors with documentation of jobs makes for more complete vendor records (and easier audit response) and increases trust with customers.

The appointment payments 530 may include any transaction information associated with the job. This may include the invoice associated with the job, the payment method, a discount coupon utilized in the transaction, and other payment information.

The follow-up information 540 may include information surrounding a follow-up task associated with the appointment 500. The follow-up information may indicate a job type (“Replace heating filter”), a target service date (“Friday—Mar. 20, 2015”), the duration between the appointment 500 and the follow-up (“5 months”), and additional background information related to the follow-up (“Carrier Heating Filter Model a632”). In some embodiments, the vendor may click on the follow-up information 540 to see more detailed information about the follow-up task. The follow-up information 540 is provided as a suggestion to the vendor and informs them that there is a potential follow-up task for the same customer associated with appointment 500. The targeted service due date may be estimated by utilizing vendor historical data or industry standard information. The vendor may look at follow-up information 540 and decide whether to accept or deny the suggestion. If the vendor confirms the suggested follow-up, embodiments may then automatically generate appointment and follow-up notifications (or other messages) to be sent to the vendor and customer when the date of recommended service approaches. Such messages are described in more detail below.

Embodiments can automatically identify follow-up items related to vendor jobs, based on certain received data from vendors and a preexisting library of data. For instance, if a vendor classifies a job as a heating filter replacement, embodiments may scan the preexisting library of data with relevant keywords, such as “heating filter replacement,” and find that industry standards recommend heating filters be replaced every 5 months. Embodiments can also apply smart semantic language interpretation to job descriptions in order to make the best possible match of related jobs and information. For example, searching for the keywords “heating filter replacement” may search for the keywords themselves along with other related or synonymous words to enable a multi-pronged search.

In a more sophisticated case, a vendor can document the make and model of a piece of equipment at the time it is installed. The vendor may manually enter equipment information to be utilized in the invoice. For example, after completing installation of a heating filter, the vendor may input that the installation was for “Carrier Heating Filter Model a632.” This equipment information can be used to estimate a target service date for a follow-up task associated with the heating filter installation. Embodiments may utilize information provided in a pre-existing database of the manufacturer's recommended maintenance intervals and estimate a target service date of 5 months. Embodiments may automatically notify a customer or vendor when service is due on the installed equipment and suggest follow-up appointment be scheduled.

In another embodiment, embodiments may display jobs associated with keyword searches by the vendor on a map. The map may give the vendor a quick idea of the locations of their completed jobs associated with the keyword search. This can be useful if the vendor wants to increase the number of jobs of a certain type. For example, the vendor may want to increase the number of jobs related to replacing a heating filter because it is more lucrative than jobs of other types that the vendor has. The vendor may search “heating filter installation” to geographically view related historical appointments on a map and determine any regions where heating filter jobs are congregated. The vendor may then seek out job opportunities in those regions.

### E. List of Follow-ups

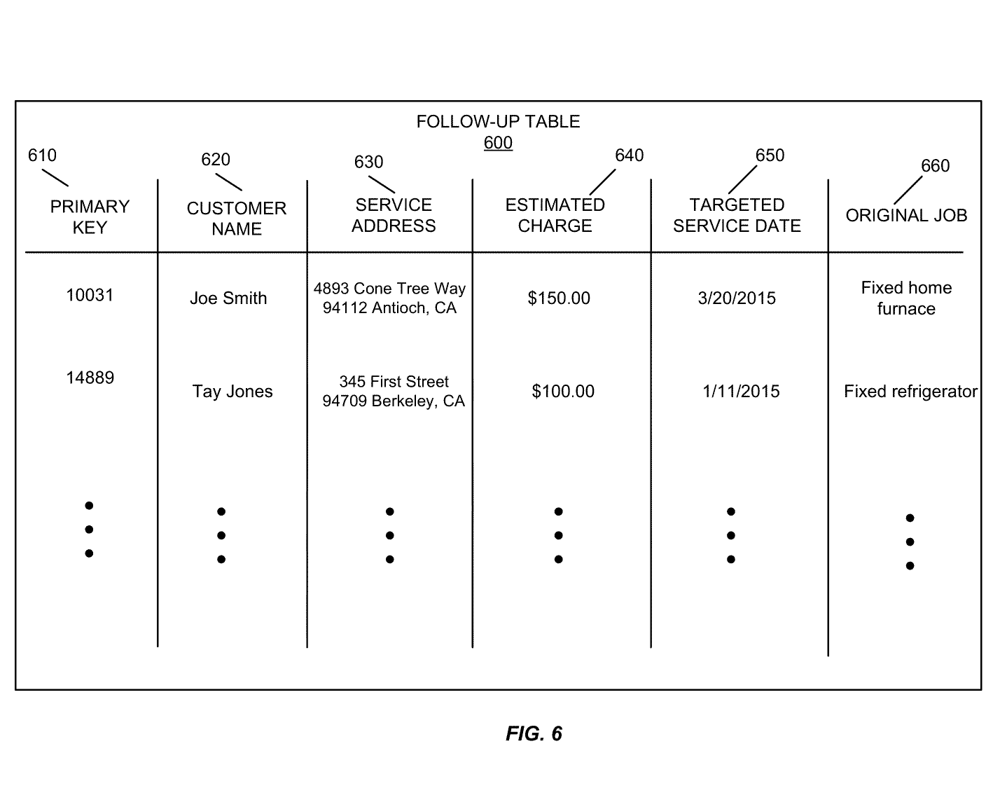

FIG. 6 shows a follow-up table that contains a list of follow-up task opportunities according to embodiments of the present invention. The follow-up table 600 may comprise information associated to follow-up tasks, such as the primary key 610, the customer name 620, the service address 630, the estimated charge 640, the targeted service due date 650, and the original job 660 that the follow-up originated from. The follow-up table 600 may be stored in the job database.

The follow-up table 600 contains information relating to all follow-up task opportunities associated with a vendor. Each follow-up task is associated with a job previously completed by the vendor. The follow-up tasks in the follow-up table 600 may be identified manually by the vendor or by suggestions based on a keyword search or historical information of the vendor's jobs. Thus, each time the vendor completes a job, a follow-up task may be added into the follow-up table 600. Each entry in the follow-up table 600 contains information associated with a follow-up task.

The primary key 610 is used to associate the original job that follow-up task in the follow-up table 600 originated from. The primary key 610 is essentially a follow-up task identifier that can link the follow-up task to the associated original job. A matching primary key may be stored in the record corresponding to the original job in the main table of the job database. For example, if the entry of a follow-up task in the follow-up table 600 contains a primary key 610 consisting of “10031”, then the record corresponding to original job in the main table can contain a field indicating the same identifier “10031.” Associating a follow-up task in the follow-up table 600 with a completed job ensures that the vendor that completed the job indicated by original job 660 is the same vendor that the follow-up task is refereed to. This assists the vendor to make recurring appointments and maintain long-term relationships with the same customers.

The customer name 620 is a field containing the name that identifies the customer of the follow-up task. This information may be automatically filled in based on information from a previously completed job or may be manually entered or edited at any time by the vendor.

The service address 630 is a field indicating the location of the follow-up task. This field may be automatically filled in based on information from a previously completed job or may be manually entered or edited at any time by the vendor. In some embodiments, the vendor may be able to access a map displaying the location of the follow-up task or the route from an existing job appointment to the service address 630.

The estimated charge 640 is a field indicating a predicted sum of money that may be charged by the vendor to the customer for the follow-up task. The estimated charge 640 may be determined by referencing historical information relating to billing of similar completed jobs by the vendor or by referencing a library containing industry standard charges for the type of follow-up task. The vendor may choose to manually override and enter a different value into the estimated charge 640 field if they believe their own estimate may be more accurate.

The targeted service due date 650 is a field indicating when the follow-up task should be scheduled. The targeted service due date 650 may be determined by referencing a targeted service database containing historical information related to the duration between recurring appointments of similar completed jobs by the vendor or industry standard information for similar types of follow-up tasks. In some embodiments, a follow-up task may result in multiple suggestions for the targeted service due date 650 referenced from various resources. The mutiple suggestions may be presented to the vendor, who may select which date to utilize. Additionally, the vendor may choose to manually override and enter a different value into the targeted service due date 650 field at any time.

The original job 660 field may contain information surrounding the job completed by the vendor that the follow-up task arose from. The original job 660 field may contain one or more of the job type, customer name, service address, or any other information about the previously completed job. This information may be useful since the vendor may be able to access information about the original job and the associated customer before scheduling or going to complete the follow-up task.

### II. Identification of Suitable Follow-Up

Follow-ups suggested to the vendor may be optimized across several variables to ensure that the vendor may receive suggestions for follow-up tasks most suitable to be added to the vendor's already existing schedule. In configuring the geographic scheduling optimization feature, the vendor would input several key variables; (i) average revenue per job; (ii) the average time per job; (iii) average travel time to job; and (iv) average profit margin per job. To the extent that such information can be inferred from the data currently in the job database, embodiments would make suggestions of suitable follow-up tasks and the vendor could then choose to accept these suggestions or make changes accordingly.

### A. Calculation of Average Hourly/Profit Revenue

The total hourly revenue of a job may be calculated using the average revenue per job, the average time per job, the average travel time per job, and the average profit margin per job. This ensures that travel time is taken into account when calculating an average hourly revenue since commute time to and from a job may not be utilized to schedule another job appointment and generate revenue.

The average revenue per job is the revenue received from all completed jobs averaged over the total number of jobs completed. This value may be entered manually by the vendor or may be automatically calculated based on historical data collected from invoices over time. The vendor may have the option to override the suggested value for the average revenue per job for any reason. In some embodiments, embodiments may periodically send the vendor an average revenue per job value calculated based on historical data and prompt the vendor whether they agree with the value. If the vendor agrees, the value may be utilized in future calculations. In some embodiments, an industry average revenue per job may also be displayed, which can provide additional information to help the vendor make a decision. In some embodiments, the vendor may simply receive a notification containing the calculated average revenue per job and not be given the ability to replace it with another value. This may be a setting set in order to minimize human calculation error.

The average time per job is the time the vendor spent at jobs averaged over the total number of jobs. The time per job is the period the vendor actually spends working on a job and does not include travel time. The average time per job may be calculated over all job types of a vendor. In some embodiments, the average time per job may be calculated over several job types to get the average time per job type. This information may be utilized to calculate an average revenue per job type to allow for optimization of follow-up tasks by job type.

The average travel time per job is the time the vendor spends travelling to and from a job. The average travel time per job may be calculated over all jobs. In some embodiments, the average travel time may be calculated over several job types to get the average travel time per job type.

The average profit margin per job is the difference between revenue and costs associated with a job. The costs may come from resources, such as tools or parts utilized by the vendor, as well as gasoline utilized during a commute. Further, labor costs may also contribute to the total cost used to calculate the average profit margin.

In an exemplary case, a vendor may be spending half an hour of travel time to get to each job, spending one hour to complete each job, and generating $100 of revenue in the process. Instead of interpreting the revenue to have resulted from an hour of work, the travel time can be taken into account as well. Since the travel time to and from each job is a total of an hour and the time spent at the job is an hour, the total revenue per hour may be calculated over a span of two hours to become $50 an hour. This information may be used to suggest a new follow-up task to the customer. If the follow-up task has a greater total revenue per hour than $50 when taking travel time into account, then this follow-up task may be a valid suggestion. In cases where the follow-up task may generate additional revenue, a suggestion to offer a discount to the customer may be be sent to the vendor. Hence, the average revenue per hour may be utilized to help determine whether a vendor should offer a discount to the customer when scheduling a follow-up task and the average profit per hour may be utilized to help determine how much of a discount should be applied.

### B. Suitability of Follow-Up from Anchor Positions

The suitability of a follow-up from a starting position, or “anchor position,” may be analyzed based on the anticipated travel time to and from the follow-up task. For a given follow-up task, embodiments may determine whether it is profitable by first anticipating the revenue, the time spent at the follow-up task, and the commute time from the anchor position to the location of the follow-up task. Hence, a specific proximity may be calculated for each anchor position indicating an area where a profitable follow-up task may reside. For example, a follow-up task that is anticipated to generate low revenue may need to be in close proximity to the anchor position in order to be a suitable follow-up because less travel time may be allowed for the follow-up task to be considered profitable. On the other hand, a follow-up task that is anticipated to generate high revenue may reside in a region that is further away from the anchor position in order to be a suitable follow-up task because the follow-up task may still garner a net profit even when the vendor takes a longer time to travel to the follow-up task location.

The anchor position may be an existing job appointment in the vendor's schedule or any other location that the vendor may be located. For instance, the vendor may be at their home and request a schedule to be provided to them on demand using their home as the anchor position. Accordingly, follow-up tasks located in certain proximities from the vendor's home may be analyzed and suggested in order of profitability to the vendor in response. Embodiments may also calculate suitable follow-up tasks in batch jobs periodically. In some embodiments, the vendor's anchor position may be set to the vendor's home by default if the vendor indicates that they will always be at home before the first appointment of the day. Embodiments may draw upon databases that contain traffic patterns around the anticipated time of the follow-up tasks in order to calculate more accurate travel times from an anchor position to a follow-up task location.

Whether a follow-up task is suitable is calculated as a function of not only the anchor position of the vendor, but also as a function of the location of the subsequent job scheduled after the follow-up task. Thus, the travel time following the potential follow-up task is also utilized to calculate whether the follow-up task is suitable. This is necessary because net profitability may vary depending on the profitability of and thus the location of the subsequent job scheduled after the follow-up task.

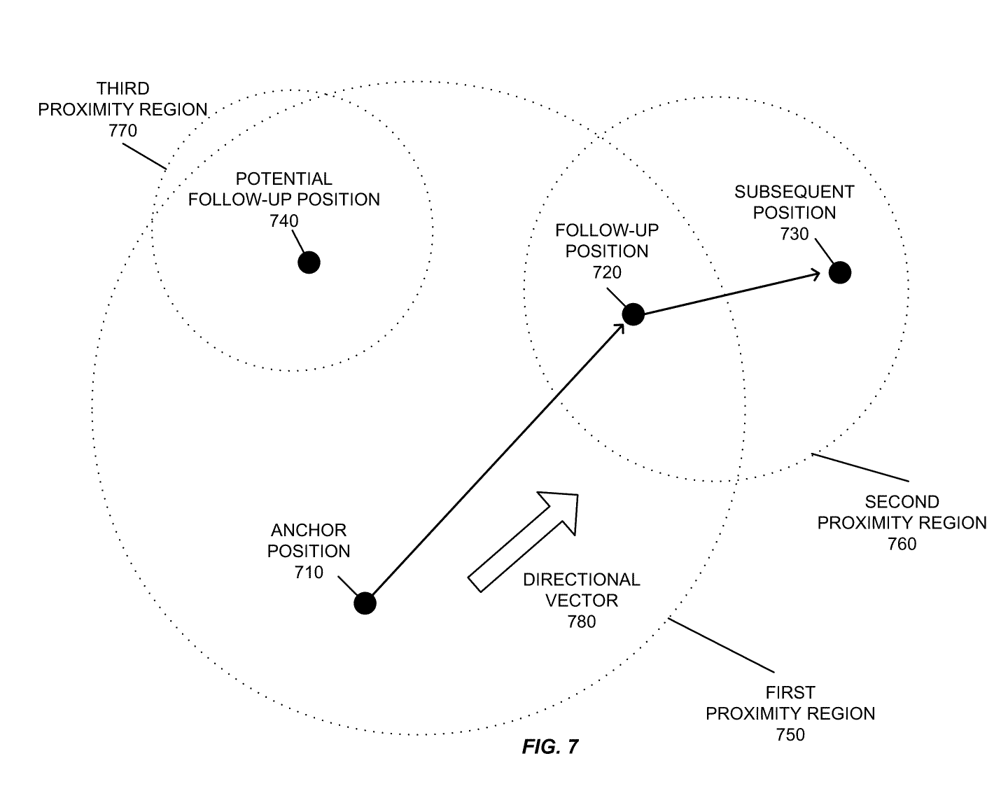

FIG. 7 shows an exemplary suitable follow-up position relative to an anchor position according to embodiments of the present invention. The vendor starts at an anchor position 710, which may be the location of an existing appointment on the vendor's schedule. The next appointment on the vendor's schedule may be located at subsequent position 730. Since there is a time gap between the times of the appointment located at anchor position 710 and the appointment located at subsequent position 730, embodiments may search through a list of potential follow-ups to try to find a follow-up task that may be scheduled to fill the free time interval. Embodiments may calculate whether a follow-up task is suitable by determining a first proximity region 750 relative to anchor position 710. Given the anticipated revenue amount and time to be spent at a follow-up task, embodiments may calculate a proximity region within which the vendor may spend time travelling to any location in the region and still garner a net positive profit or a higher revenue rate than normal. Given the anticipated revenue and time to be spent at the follow-up associated with follow-up position 720, embodiments may determine that the follow-up task may be located anywhere within the first proximity region 750 and still be profitable for the vendor.

Additionally, the appointment that would be scheduled after the follow-up task must be considered before the follow-up task is deemed suitable. The appointment may be located at subsequent position 730. Embodiments may calculate a second proximity region 760 relative to the follow-up position 720 similar to the way the first proximity region 750 was calculated. Since the subsequent position 730 is located within the second proximity region 760, this indicates that the travel time spent commuting between the appointments at follow-up position 720 to appointment at subsequent position 730 will not hinder the vendor's ability to gain a net positive profit or a higher revenue rate than normal. Hence, given the fact that the follow-up position 720 is located within the first proximity region 750 and the subsequent position 730 is located within the second proximity region 760, embodiments may deem the follow-up task associated with follow-up position 720 suitable and suggest the vendor to add it to their schedule.

The reason why the position of the appointment following the follow-up task must be taken into account is explained with reference to potential follow-up position 740. The follow-up task associated with potential follow-up position 740 may have the same anticipated revenue and time to be spent at the job as the follow-up task associated with follow-up position 720. A third proximity region 770 may be identified relative to the potential follow-up position 740. While the potential follow-up position 740 lies within the first proximity region 750, the subsequent position 730 does not lie in the third proximity region 770. Thus, the follow-up task associated with potential follow-up position 740 may not be deemed suitable to schedule in between the appointments associated with anchor position 710 and the subsequent position 730.

In some embodiments, a directional vector may be calculated to assist searching for suitable follow-up tasks. For instance, instead of calculating a proximity region to include all directions surrounding a position as shown in FIG. 7, certain directions may be ruled out of the proximity region to eliminate certain potential follow-up tasks more quickly. For instance, since the directional vector 780 between anchor position 710 and subsequent position 730 is pointing Northeast, any region Southwest of the anchor position may be ruled out of the proximity region 710. Accordingly, potential follow-up tasks located Southwest of the anchor position 710 may not be considered at all, which can reduce calculations to find suitable follow-up tasks.

### C. Example Order of Operations

In some embodiments, follow-up task suggestions may be determined, e.g., as long as the follow-up tasks satisfy a threshold. They follow-up tasks can be ranked, e.g., based on revenue rate.

The follow-up table associated with the vendor may be accessed to search through potential follow-up tasks. The average revenue per hour of the follow-up tasks may then be calculated. For each follow-up task stored in the follow-up table associated with a vendor, the anticipated revenue may be calculated based on the vendor's historical job information or third-party databases. Further, the time to be spent at the follow-up task, as well as the commute time associated with the follow-up task may be estimated based on the vendor's historical job information or third-party databases. The anticipated revenue and total time put towards the follow-up task, including the time to be spent working and the travel time, may be utilized to calculate the total revenue per hour of the follow-up task.

The difference between the average revenue per hour estimated for a follow-up task and the total average revenue per hour of a vendor may then be compared to a threshold value to determine whether certain follow-up tasks can be considered suitable. This threshold may be set by the vendor and may be changed at any time. If the average revenue per hour calculated for a follow-up task is greater than the total average revenue per hour of a vendor by an amount greater than the threshold, the follow-up task can be deemed suitable.

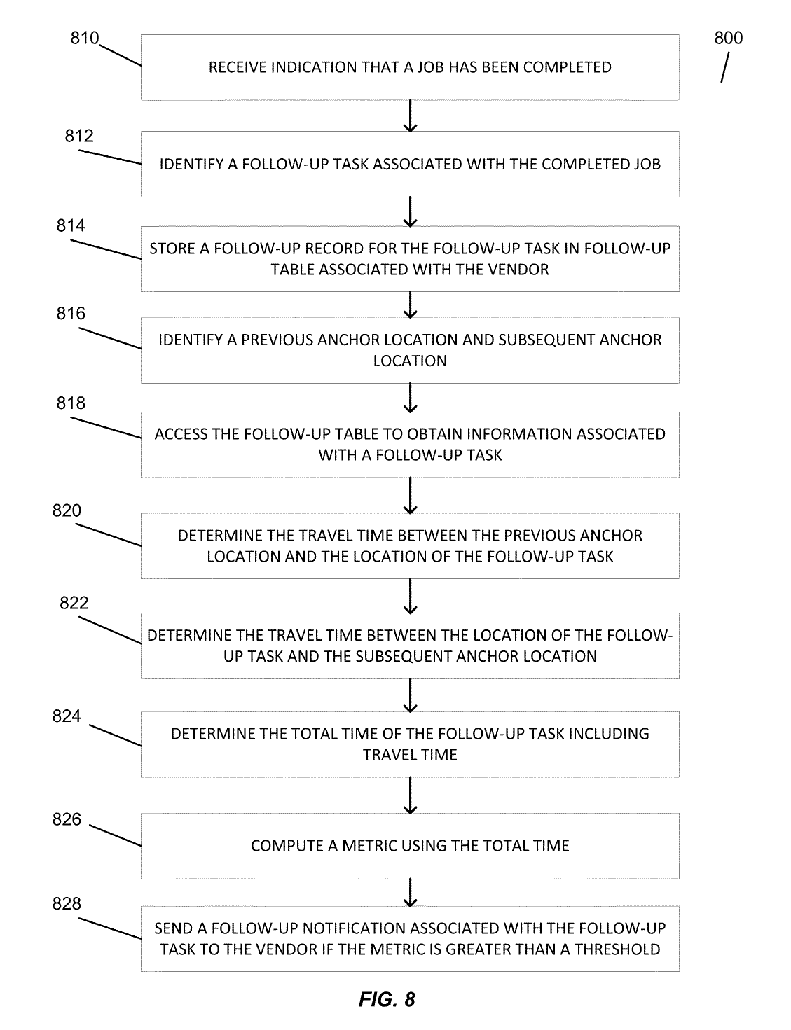

In some embodiments, the threshold determining a suitable follow-up task may be associated with an amount of time. Thus, follow-up task and coupon suggestions may be determined without calculation of average revenue per hour calculation. FIG. 8 describes these embodiments in more detail.

Any follow-up task determined to be suitable based on the set threshold may be sent to the vendor as suggestions. In some embodiments, multiple follow-up tasks may be found to be suitable suggestions. The suitable follow-up tasks may then be ranked by greatest variance from the set threshold. The follow-up tasks may then be provided to the vendor in a table with suggestions ranked by greatest profitability or suitability determined based on the set threshold.

Determining the suitability of follow-up tasks based on a threshold as described above can be useful in several ways. The calculations do not rely on geographic searches. In some cases, it may be faster to forgo utilizing geographic information to determine a suitable follow-up task because of issues that may arise with determining a proximity region or the geographic based calculations taking a longer time.

### D. Method

Embodiments have two specific modes for geo-scheduling optimization; (i) continuous; and (ii) on demand. In continuous mode, this geographic scheduling suggestion engine could be configured to run once per day or once per week. Alternatively, the feature could be engaged on demand where the vendor would engage the feature manually. Embodiments would be self-optimizing based on what coupon suggestions vendors have selected historically in order to refine the algorithms to make more accurate follow-up task suggestions based on the vendor's historical suggestions.

FIG. 8 shows a flowchart illustrating a method according to embodiments of the present invention. Embodiments may be described with reference to FIG. 1.

At step 810, the server computer 130 may receive an indication that a job has been completed by the vendor. This indication may be manually inputted by the vendor when the vendor leaves the job location. In some embodiments, the vendor may be prompted whether the job has been completed after leaving a certain region around the job location tracked by the GPS 123. The vendor may then confirm that the job has been completed.

At step 812, a follow-up task associated with the completed job may be identified. The vendor may manually enter the information associated with a follow-up task or accept a suggestion for a follow-up task. Making a suggestion may comprise referencing a third party database containing information or historical information of the vendor's jobs in order to estimate a target service due date for a follow-up task. In some embodiments, a follow-up task may be identified based on predetermined information regarding a specific make or model of equipment associated with the completed job.

At step 814, the server computer 130 may store a follow-up record for the follow-up task identified in step 812 into the follow-up table associated with the vendor. The follow-up task can be associated with the completed job by storing a matching primary key, or follow-up identifier, in the follow-up table associated with the vendor as well as in the record associated with the completed job in the main table. The data stored in the follow-up record may be automatically populated from information captured from the invoice created for the associated completed job. Any information entered manually or overridden by the vendor may be stored in the follow-up record as well.

At step 816, a previous anchor location and a subsequent anchor location may be identified in response to a trigger. A trigger may be an on-demand request from the vendor to run the geo-scheduling optimization algorithm or may be a batch job running periodically. After a trigger is activated, a previous anchor location and a subsequent anchor location may be identified. The previous anchor location may correspond to the location of a first job existing in the vendor's schedule. The subsequent anchor location may correspond to the location of a second job scheduled after the first job on the vendor's schedule. There are no jobs scheduled between the first job and the second job.

At step 818, information associated with a follow-up task may be obtained by accessing the follow-up table. The server computer 130 may search through the follow-up tasks stored in the follow-up table associated with the vendor. For simplicity, it is assumed that only one follow-up task exists in the follow-up table. However, other embodiments may comprise a follow-up table containing multiple follow-up tasks and processes described in steps 818 through 828 are carried out for each follow-up task. The information associated with the follow-up task may be obtained from the record associated with the follow-up task in the follow-up table. The information may include the primary key, customer name, service address, estimated charge, targeted service date, and associated original job.

At step 820, the travel time between the previous anchor location and the follow-up task location may be determined. The travel time between previous anchor location and the follow-up task location may be determined based on historical information relating to travel times of the vendor's previous jobs or predetermined information stored in a library or database. In some embodiments, information relating to traffic and parking conditions corresponding to the specific route or region between the previous anchor location and the follow-up task location may be utilized to determine the travel time.

At step 822, the travel time between the follow-up task location and the subsequent anchor location may be determined. The travel time between the follow-up task location and the subsequent anchor location may be determined based on historical information relating to travel times of the vendor's previous jobs or predetermined information stored in a library or database. In some embodiments, information relating to traffic and parking conditions corresponding to the specific route or region between the follow-up task location and the subsequent anchor location may be utilized to determine the travel time.

At step 824, the total time of the follow-up task may be determined. The total time can be equal to the sum of the first travel time determined in step 820, the time duration of the follow-up task, and the second travel time determined in 822. The time duration of the follow-up task may be determined based on historical information of the vendor's previously completed jobs.

At step 826, a metric may be computed utilizing the total time calculated in step 824. The metric may measure a monetary difference amount or a time difference amount.

In some embodiments, the metric may measure a monetary difference amount utilizing the total time of the follow-up task. For instance, the estimated average revenue per hour of the follow-up task may be calculated, which is calculated by averaging the estimated revenue of the follow-up task across the total time of the follow-up task. The estimated average revenue per hour of the follow-up task can then be compared to the total average revenue per hour of the vendor. The total average revenue per hour of the vendor can be calculated by averaging the total revenue generated by the vendor's jobs over the sum of all times, including travel time, for the vendor's jobs. The metric is equal to the difference between the estimated average revenue per hour of the follow-up task and the total average revenue per hour of the vendor.

In some embodiments, the metric may measure a time difference amount utilizing the total time of the follow-up task. For instance, an allowable time between the first job associated with the previous anchor location and the second job associated with the subsequent anchor location may be determined. The allowable time can be determined by calculating the difference between the ending time of the first job and the starting time of the second job. The metric is equal to the time difference between the allowable time and the total time of the follow-up task.

At step 828, a follow-up notification may be sent to the vendor associated with the follow-up task under the condition that the metric calculated in step 826 is greater than a threshold.

The threshold may be determined in multiple ways. For instance, the vendor may determine and enter a threshold manually. In some cases, the vendor may choose a range associated with the threshold mapped to a preference scale. For example, the preference scale may allow the vendor to choose amongst “aggressive,” “moderate,” and “low” thresholds. In some embodiments, the threshold may be automatically set or calculated based on historical threshold settings or other historical information of the vendor.

The threshold value can be compared to the metric to determine whether the follow-up task is suitable. When the metric is a monetary difference amount, the threshold value can indicate the minimum value by which the average revenue per hour of the follow-up task should exceed the total average revenue per hour of the vendor in order for the follow-up task to be considered suitable. For example, if the vendor indicates that the the average revenue per hour of the follow-up task should be greater than the total average revenue per hour of the vendor, the threshold would equal zero.

Additionally, when the metric is a time difference amount, the threshold value indicates the minimum value by which the allowable time between the first job at the previous anchor location and the second job at the subsequent anchor location should exceed the total time of the follow-up task in order for the follow-up task to be considered suitable. For example, if the vendor indicates that the allowable time should be greater than the total time of the follow-up task, the threshold would be zero.

### E. Examples

The following are several examples of additional situations under which the embodiments may operate. In some cases, a vendor may notice that they have a whole day open in their schedule. The vendor may request the platform to create a schedule consisting of only follow up tasks. Embodiments may access the follow-up table associated with the vendor and calculate the suitability of each follow-up task relative to an anchor location specified by the vendor. For example, the anchor location may be the vendor's home or vendor's office. Subsequent follow-up task locations may be calculated in a similar manner. Potential schedules made up of all follow-up tasks may then be presented to the vendor, who may then accept or deny certain schedules. The vendor may schedule the follow-up tasks by contacting the associated customers. In some embodiments, customers may be automatically contacted with an email, text message, or any other suitable form of communication when the vendor accepts a schedule.

In some cases, a schedule may be optimized by reorganizing appointments in a different order than originally scheduled. Embodiments may reorganize the vendor's schedule such that time that was not previously available can become freed. The newly opened time intervals may be used to schedule new follow-up tasks. For example, embodiments may recognize that three job appointments are located in San Francisco, San Jose, and San Francisco, respectively, and that reordering the second and third appointments may result in an open interval during which a follow-up task may be scheduled. At this point, it may be calculated whether a discount may be offered to any customers associated with the follow-up tasks or the appointments to be rescheduled.

However, if it can be inferred from historical information that the vendor's customers have a low coupon conversion rate, embodiments may allow the vendor to contact the customers to reschedule only if multiple plausible schedule options containing different follow-up tasks exist. For example, embodiments may check to make sure at least two follow-up tasks are plausible with the vendor's schedule when it is known that there is a 50% coupon conversion rate. After at least two plausible follow-up tasks are found, the platform may allow the vendor to decide whether or not to contact customers to reschedule their original appointments.

In some cases, a vendor may consist of multiple technicians that may each have their own schedules and each receive follow-up suggestions. Embodiments may offer schedule optimization suggestions to each individual technician's schedule as well as across multiple technicians' schedules. For example, if the vendor manages eight technicians, schedule optimization may be calculated across all eight technicians' schedules and provide suggestions to reassign certain jobs amongst technicians. For instance, if a first technician has all job appointments for the day in San Francisco except for one appointment in San Jose, and a second technician has all job appointments for the day near San Jose, the first technician's appointment in San Jose may be reassigned to the second technician if the second technician's schedule permits. This may free up a time interval in the first technician's schedule during which a follow-up task may be scheduled and increase the vendor's total revenue per hour. The capability to carry out schedule optimization across a multi-technician operation is beneficial because reassigning jobs between technicians forgoes the need to reschedule customers' original appointment times, which can be cumbersome.

In some cases, the vendor may receive a summary of their historical schedules with additional information about follow-up tasks that potentially could have been added to their schedules. For example, the vendor may be presented with a schedule from the past week along with information, such as total revenue per hour, generated based on the schedule. Additionally, the historical schedule may display potential follow-up tasks that the vendor did not choose to add into their schedule last week along with information, such as total revenue per hour, that could have been generated had certain follow-up tasks actually been scheduled. The analysis can be applied to longer periods of historical data as well. For example, embodiments may inform the vendor with an analysis informing that based on current follow-ups in the job database and the vendor's historical schedule from last quarter that they could have generated a certain amount of money in extra annualized revenues. The historical schedule may provide the vendor a method to easily view the benefits of scheduling follow-up tasks by a statistical analysis and quickly compare the quantitative changes that may arise from accepting suggestions arising from schedule optimization calculations.

Embodiments can offer analytics tools for vendors to reveal the current state of their business and illuminate ways to improve it. Insights such as lifetime value, yields, and customer acquisition costs can be produced through the collection of certain metrics. Vendors can compare their own business to that of other businesses to see where they stand. Intelligence on past work can be directly useful to vendors in their scheduling and time budgeting as predictive algorithms and analytics can constantly improve based on actual historical data from the vendor. The data can be used to dynamically create reporting on core business metrics for vendors, such as utilization, travel density of appointment, miles traveled, payment collections, revenue trends, etc. Analytics information can be produced on demand for vendors, or can be sent to them at certain intervals (e.g. in a weekly digest email).

### III. Discount

When a vendor wants to schedule a follow-up task in order to avoid an open block of time in their schedule, the vendor may choose to offer a discount to the customer associated with the follow-up task. Embodiments may calculate whether a discount can be offered to the customer and still turn a net positive profit. If so, embodiments may algorithmically determine the magnitude of the discount that should be applied in order to meet any configuration setting for follow-up task suggestions set by the vendor. For example, such settings may include that the average revenue per hour generated by a follow-up task must be at least the average revenue per hour calculated over all of the vendor's jobs. Accordingly, only a discount that allows the revenue per hour of the follow-up task to be the same or higher than the vendor's overall revenue per hour may be suggested to the vendor and therefore be offered to the customer. This “automated intelligence” method to determine coupon rates may assist the vendor in becoming more profitable since the automated analysis reduces the cost of capturing repeat business, and increases the lifetime value of customer relationships without the awareness or effort otherwise required to do so.

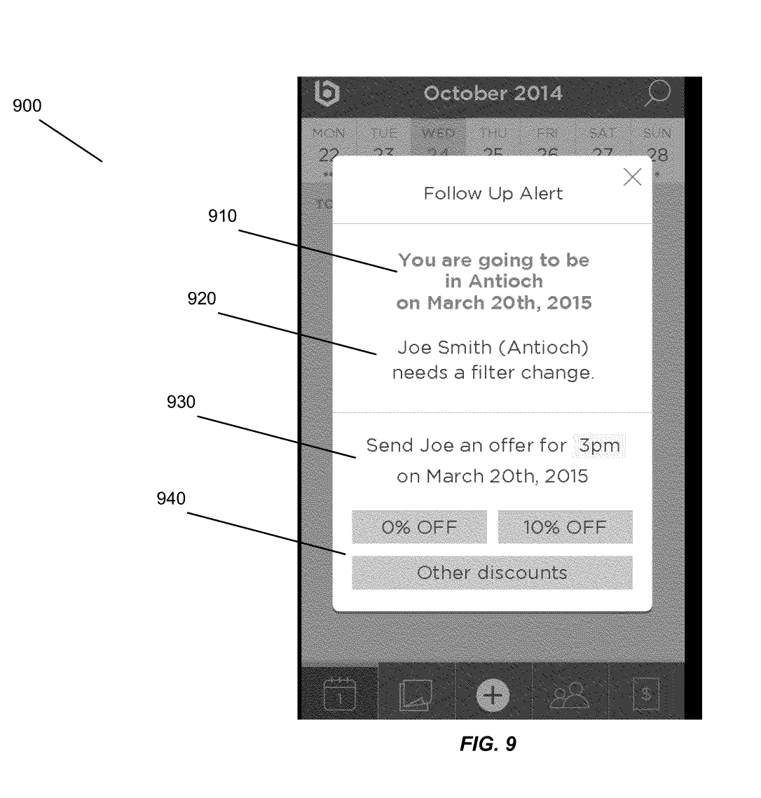

FIG. 9 contains an exemplary display showing a follow up notification containing discount rate suggestions sent to the vendor according to embodiments of the present invention. The follow-up notification 900 may alert the vendor of a potential follow-up task after schedule optimization is triggered to run. The follow-up notification 900 may contain existing schedule information 910, follow-up identification information 920, follow-up appointment information 930, and discount suggestions 940.

The follow-up notification 900 may contain existing schedule information 910 that informs the vendor of information, such as the location (“Antioch”) and date (“Mar. 20, 2015”), about an original job in the vendor's schedule that is associated with the follow-up task.

In some embodiments, the existing schedule information 910 may be linked to more detailed information regarding the existing job. In some embodiments, the vendor may view more detailed information about the schedule information 910, such as the associated customer name, service address, estimated charge, and any other pertinent information.

The follow-up notification 900 may further contain follow-up identification information 920 that helps identify the follow-up task to the vendor, such as customer name (“Joe Smith”), location (“Antioch”), and job type (“filter change”). In some embodiments, the follow-up identification information 920 may be linked to further information regarding the follow-up task. The vendor may view more detailed information about the identification information 920, such as the associated service address, estimated charge, and any other pertinent information.

The follow-up notification 900 may further contain follow-up appointment information 930 that may inform the vendor when the follow-up task would be scheduled. For instance, the follow-up appointment information 930 may include the date (“Mar. 20, 2015”) and time (“3 PM”) of the follow-up task.

The follow-up notification 900 may further contain discount suggestions 940. The follow-up notification 900 may display multiple discount options that are calculated to be appropriate discount rates based on comparing the total revenue per hour across all of the vendor's jobs and the estimated average revenue per hour of the follow-up task. The displayed discount options (“0% off” and “10% off”) may correspond to discount rates that the vendor may choose to offer to the customer associated with the follow-up task and still generate profit. Additional discount options (“Other discounts”) may still be offered to the vendor to view in case the vendor decides to choose a larger discount for any reason. For instance, the vendor may decide that maintaining a long-lasting relationship with the customer associated with the follow-up task is more important than making a profit. The vendor may know from experience that the particular customer typically accepts discount rates that are 15% or higher and thus may purposefully choose a higher discount rate than the displayed discount options. Thus, while the follow-up notification 900 may suggest various discount rates to offer with a follow-up task, the vendor may choose to offer other discount rates to the Customer.

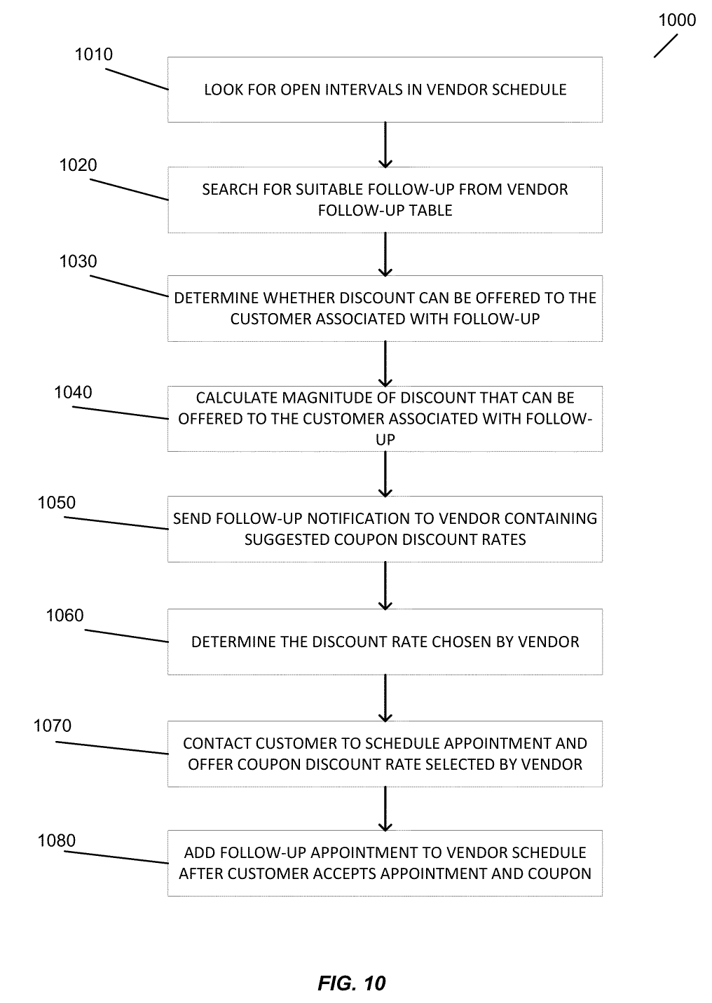

FIG. 10 shows a flowchart comprising the process 1000 taken to suggest a follow-up task and associated coupon discount rates to a vendor according to embodiments of the present invention.

At step 1010, embodiments may look for open time intervals between existing appointments in the vendor's schedule. There may be a set minimum amount of time in which scheduling a follow-up task may be considered. Accordingly, embodiments may look for any free time intervals equal to or greater than this minimum amount of time before follow-up tasks are searched.

At step 1020, if a time interval greater than the minimum amount of time exists, then suitable follow-up tasks in the follow-up table associated with the vendor may be searched. For each follow-up task, embodiments may calculate the corresponding total revenue per hour and determine whether it is profitable for the vendor to add it into their schedule.

At step 1030, after a suitable follow-up is found, embodiments may determine whether a discount can be offered to the customer associated with the follow-up task. Embodiments may check regulations that the vendor may have set regarding when a discount should be offered. For instance, the vendor may have total revenue per hour taken over all of the vendor's jobs of $80. The vendor may indicate that a follow-up task should only be offered if the total revenue per hour of the follow-up task is at least $80. Hence, it may be determined that only a discount should be offered if the follow-up task generates total revenue per hour greater than $80.

At step 1040, if it is determined that a discount can be offered to the customer, the magnitude of the discount rate to be suggested is calculated. For example, based on the vendor's regulations, if the total revenue per hour of the follow-up task is calculated to be $100, then a discount rate of any percentage lower than 20% may be determined suitable since the total revenue per hour of the follow-up task would still be greater than $80 with the discount applied.

At step 1050, a follow-up notification may be sent to the vendor containing potential discount rates. The follow-up notification may identify the customer and job type of the follow-up task and also suggest several discount options that the vendor may choose to offer to the customer. For example, if the discount options may be any discount rates lower than 20%, then discount such as, “15% off” or “10% off,” may be suggested. An option to not offer a discount at all may be by provided by a “0% off” suggestion. The vendor may review the discount suggestions provided by the follow-up notification and either select a suggested discount rate or manually enter a different discount rate to offer to the customer.

At step 1060, the discount rate chosen by the vendor may be determined. The corresponding coupon information may be stored in the follow-up table associated with the vendor.

At step 1070, the vendor may be notified to contact the customer to schedule the follow-up task and send the coupon discount offer. In some embodiments, the customer may be contacted automatically after the vendor accepts a follow-up task and chooses a discount rate. The customer may review the offer and decide whether or not they want to schedule the appointment for the follow-up task with the vendor. The customer may be more inclined to schedule the appointment if the charge is discounted.

At step 1080, after the customer accepts the appointment and coupon, an appointment associated with the follow-up task may be added into the vendor's schedule. The customer and job information related to the follow-up task may be added into the follow-up table associated with the vendor. The open time interval found in the vendor's schedule in step 1010 is now replaced with a follow-up task that may increase the vendor's profit as well as help maintain a recurring relationship with the customer associated with the follow-up task.

### IV. Appointment Scheduling and Notifications

In some embodiments, the vendor inputs the customer's address (and possibly other information, such as name, contact details, job request, etc.) into the mobile application. Each data entry must only be done one time, and notes fields are populated by the vendor. Application data may be stored in a database both on the vendor's mobile device (e.g., smartphone) and also in the cloud. When a new job is scheduled, a record associated with the job is automatically created. The mobile application may display a summary of the details of the customer and job information as well as provide one click access to contact the customer, collect payment, see a map of the job location, etc.

### A. Optimized Scheduling

Suggested appointment dates and times can be calculated based on a number of parameters, which may include but are not limited to the customer's address, availability, and type of service request, and the vendor's availability and location of other jobs, including estimated drive time between customer locations. Suggested appointments are chosen to minimize costs and maximize revenue (i.e. they are often clustered by proximity and driving routes are optimized). Embodiments can automatically suggest the most efficient time to schedule a follow-up task based on the location of the follow-up task in relation to all pre-existing appointments. The vendor can accept the recommendation or manually schedule an alternative time slot.

In some embodiments, customers may input their address and other information in order to see available appointments (also calculated from the analysis described above), and may select one.

After the appointment is selected (automatically or manually by the vendor or customer), a notification can be sent to the customer and/or vendor that the appointment has been scheduled. This notification may be sent via text message, email, phone call, or other method; customers and vendors may indicate which method is preferred, and the preferred method will be used if available. Further notifications may be set at other predetermined times, such as the night before an appointment, or when the vendor approaches within a specified number of miles or driving minutes of a customer's location.

Some notifications may require action to be taken by the customer and/or the vendor in order for the appointment to be kept. For example, a customer may receive a message reminding him of an appointment the next day, with a prompt for him to confirm the appointment. If the customer confirms the appointment by clicking a button, swiping his finger on the touchscreen, or taking some other action, then the appointment will be kept. If the customer does not confirm, then the appointment will be cancelled and a notification of the cancellation may be sent to both the vendor and customer. A prompt to schedule for a new appointment may be sent to the customer or vendor as well.

Some notifications may include optional actions that a customer can take as related to an appointment. For example, the reminder message sent to a customer may include prompts to change or cancel appointments, see a photo of the technician who will be doing the service, or view a map of the technician's current location as they approach the customer site. In some embodiments, rich notifications may include some of the aforementioned information without the customer taking any additional action.

### B. “Living Schedule” Module

Some embodiments can include a “Living Schedule” module that tracks certain data parameters to provide scheduling information to vendors and customers. For example, embodiments can monitor the vendor's location, location of the vendor's jobs, area weather, and traffic and parking conditions during the workday. These and other data points can be collected and analyzed to determine if the vendor is running on schedule or not, and send out notifications or real-time updates to the vendor and/or customer.

In one example, the following data may be collected: the vendor is currently located at his first job of the, his second job that day begins in 30 minutes, and the driving distance between the two jobs is 100 miles. Based on the vendor's current location and scheduling data indicating the location and time of the his second job, it may be calculated that the vendor is going to be late for his second job. Accordingly, the vendor may receive a notification that he should leave as soon as possible for the second job. The customer associated with the second job may also receive a notification informing the customer that the vendor will be late along with an estimated arrival time of the vendor. The customer may receive a futher notification automatically when the vendor crosses into a geofence (a virtual perimeter for a real-world geographic area) around the location of the second job tracked by the GPS of the vendor's mobile device. The customer may also check the vendor's status to get real-time updates on the new arrival time, which can be calculated based on the vendor's location, speed, traffic and weather conditions, and other factors. This is beneficial for customers, as they can plan to do other things rather than simply wait around for a late vendor. When a vendor leaves a geofence around the current job, the vendor can automatically be prompted whether the current job has been completed.

### V. Additional Functionality

### A. Format/Onboarding

Some embodiments may take the form of a cloud software application with web and mobile interfaces that may be accessed via a computer, mobile phone, tablet, or other device. Users may download the software to their device from the Internet, and can then set up an account as follows: vendors may be prompted to enter information about their business, and may auto-fill business information if the entered data matches any pre-existing listings in the system or a related third party system. Vendor profile pages may be created displaying selections of their business information. Vendors may also have the option to import their contacts and calendar information and to enter their photo and contact information. Vendors may be shown a confirmation screen in the event that their data entry is successful.

### B. Superimposed Image

Some embodiments may superimpose a number equivalent to the number of follow-up tasks associated with a customer onto the photo associated with the customer's contact information stored in the vendor's mobile device. If there is no photograph already present in the customer's contact information, a new image file is created featuring the number of follow-up tasks associated with the customer. When the customer calls the vendor, the caller-ID on the vendor's mobile device will display the superimposed image file associated with the customer to be displayed. This can immediately alert the vendor that there are a certain number of follow-up tasks in the job database for that specific customer.

### C. “On Time” Score

Some embodiments may calculate an “on time” score for vendors that tracks their punctuality, which may be used for reference by customers when deciding whom to hire.

Punctuality data can be inferred and calculated automatically based on the start time and address of an appointment and the current GPS location of the vendor. This score could be weighted, such that lateness due to certain events (such as traffic due to an unanticipated vehicle accident on a lightly traveled road) would count less against the vendor's score than other events (like foreseeable traffic on a major throughway at rush hour). Industry averages of “on time” scores may also be displayed to the customer in a ranking or statistical distribution so that the customer may easily compare the vendor's punctuality to that of other vendors. Thus, vendors may be ranked for punctuality on an absolute basis or relative score basis.

Some embodiments can calculate dependability scores for customers in a similar fashion to track their no-shows or cancellation of appointments. Vendors can use this information in deciding which jobs to accept, so that they might avoid customers who are chronic no-shows. The dependability score may be calculated in a similar manner to the puncutality scores in that they may be weighted due to certain events or displayed in a direct ranking or statiscal distribution against dependability scores of other customers. Thus, customers may be ranked for dependability on an absolute basis or relative score basis as well.

### D. Direct Communication Path

Embodiments allow customers and vendors to easily communicate with each other. This communication may take the form of direct contact (e.g. a text message, email, phone call, etc.) or indirect contact, such as review submissions (of the vendor or customer) and marketing campaigns. Communication can occur with just one touch of a button. For example, a vendor making his way to a job may be shown an interface that includes a “Call customer” button. These features help to allay the communication problems that are a common source of stress associated with onsite vendor-customer relations.

### E. “Activity Stream” Module

Certain embodiments include an “activity stream” module that shows vendors their business activity, i.e. what they did, where, when, and for whom. Activity stream data is derived from collected inferred data as well as from manual actions taken by the vendor. The activity is searchable and filterable, and can be displayed in list, map, and other forms. For example, a plumber might search the activity stream for “hot water heater replacement” and be presented with data from all of the jobs the plumber completed that included a hot water heater replacement, where and when they were done, what problems were encountered, what equipment was installed, and who the customers were. These jobs can be displayed as a list, on a map, or output into certain formats, such as .CSV to make it workable as a spreadsheet. Work displayed in the activity stream can also be exported as a portfolio of work, so that vendors can easily gather and display it in a well-presented package to potential customers.

### F. Contextual User Interface Design

The interface of certain embodiments may change depending on certain factors; this is called a “Contextual Design”. For example, on workday mornings before any scheduled jobs, a vendor may view his upcoming schedule for the day, which allows him to mentally prepare and gather the tools and materials he will need. Suggestions of what tools and parts may be used may be generated based on historical job data, templates manually entered by the vendor, and third party databases. When the vendor is driving between jobs, he can see a map or street view of his destination. When the vendor is at a job working, the interface may default to an array of logging options that will make it convenient to take pictures or notes related to the job while he works. These kinds of interface customizations can be built into the software for a wide array of scenarios and in response to data both explicitly entered by vendor and passively collected from the vendor's device's sensors, including GPS, accelerometer, and microphone.

The interface and features may also be tailored according to specific trades. These embodiments are programmed to recognize the specific needs of different vendor verticals. For example, a plumber would not see a list of HVAC equipment in a pre-loaded library of materials.

Embodiments may employ a “popover”-type user experience in their interface.

### VI. Computer System

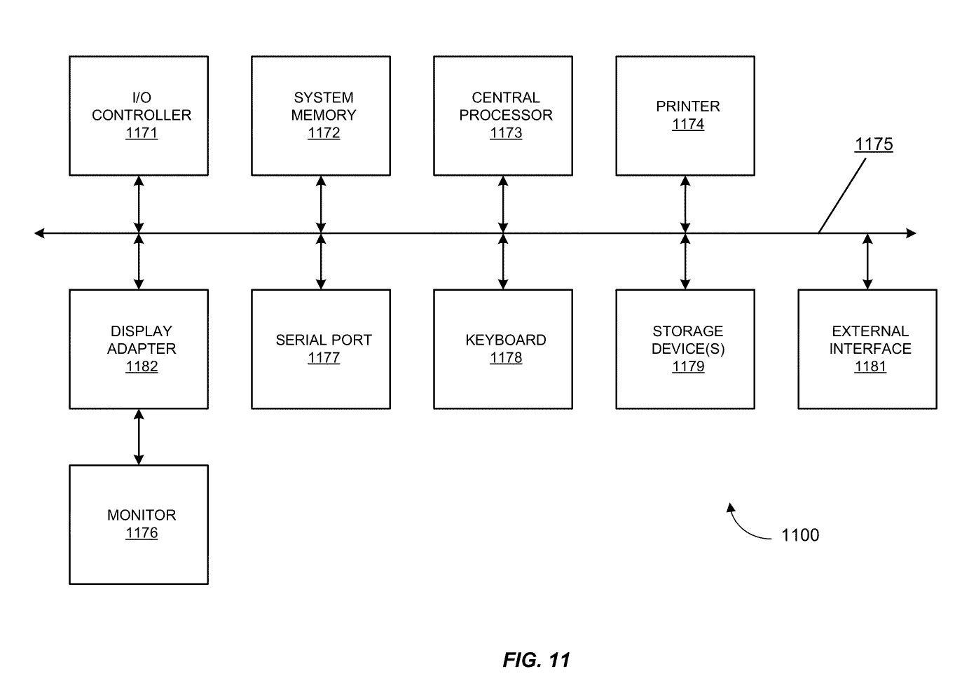

Any of the computer systems mentioned herein may utilize any suitable number of subsystems. Examples of such subsystems are shown in FIG. 11 in computer apparatus 1100. In some embodiments, a computer system includes a single computer apparatus, where the subsystems can be the components of the computer apparatus. In other embodiments, a computer system can include multiple computer apparatuses, each being a subsystem, with internal components.

The subsystems shown in FIG. 11 are interconnected via a system bus 1175. Additional subsystems such as a printer 1174, keyboard 1178, storage device(s) 1179, monitor 1176, which is coupled to display adapter 1182, and others are shown. Peripherals and input/output (I/O) devices, which couple to I/O controller 1171, can be connected to the computer system by any number of means known in the art, such as serial port 1177. For example, serial port 1177 or external interface 1181 (e.g. Ethernet, Wi-Fi, etc.) can be used to connect computer system 1100 to a wide area network such as the Internet, a mouse input device, or a scanner. The interconnection via system bus 1175 allows the central processor 1173 to communicate with each subsystem and to control the execution of instructions from system memory 1172 or the storage device(s) 1179 (e.g., a fixed disk, such as a hard drive or optical disk), as well as the exchange of information between subsystems. The system memory 1172 and/or the storage device(s) 1179 may embody a computer readable medium. Any of the data mentioned herein can be output from one component to another component and can be output to the user.

A computer system can include a plurality of the same components or subsystems, e.g., connected together by external interface 1181 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As user herein, a processor includes a multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C# or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

All patents, patent applications, publications, and descriptions mentioned here are incorporated by reference in their entirety for all purposes. None is admitted to be prior art.

What is claimed is:

1. A method of providing a schedule for a vendor, the method comprising performing, by a computer system:
receiving, from a vendor, an indication that a job has been completed for a customer at a customer address, wherein the customer is stored as a customer record in a main table of a database;
identifying a follow-up task that is associated with the completed job;
storing a follow-up record for the follow-up task in a follow-up table in the database that is associated with the vendor, the follow-up table including a plurality of follow-up tasks associated with a plurality of completed jobs;
in response to a trigger, identifying a previous anchor location and a subsequent anchor location;
for each of a plurality of follow-up tasks in the follow-up table:
accessing the follow-up table to obtain:
the customer address for the follow-up task, and
a task duration of the follow-up task;
determining a first travel time between the previous anchor location and the customer address of the follow-up task;
determining a second travel time between the customer address of the follow-up task and the subsequent anchor location;
determining a total time for the follow-up task from the first travel time, the task duration, and the second travel time;
computing a metric using the total time;
providing the follow-up task in a message to the vendor when the metric is greater than a threshold.

2. The method of claim 1, further comprising:
for each of the plurality of follow-up tasks in the follow-up table:
accessing the follow-up table to obtain a monetary value associated with the follow-up task,
wherein computing the metric using the total time includes:
computing a follow-up monetary rate using the monetary value and the total time; and
determining a rate difference between the follow-up monetary rate and a baseline monetary rate, wherein the rate difference is the metric.

3. The method of claim 2, further comprising:
receiving an estimated departure time from the previous anchor location and a required arrival time at the subsequent anchor location, wherein the total time for the follow-up task is less than the difference between the required arrival time and the estimated departure time.

4. The method of claim 3, wherein determining the first travel time is based on historical traffic patterns between the previous anchor location and the customer address at the estimated departure time, and wherein determining the second travel time is based on historical traffic patterns between the customer address and the subsequent anchor location at the estimated departure time.

5. The method of claim 1, further comprising:
in response to a trigger, identifying an ending time for the previous anchor location and a starting time for the subsequent anchor location,
wherein computing the metric using the total time includes:
computing an allowable time between the starting time and the ending time;
calculating a time difference between allowable time and the total time, wherein the time difference is the metric, and wherein the threshold is zero.

6. The method of claim 1, wherein the monetary rate is a revenue rate or a profit rate, and wherein the threshold is a positive number.

7. The method of claim 1, wherein the baseline monetary rate is an average monetary rate of the vendor.

8. The method of claim 1, further comprising:
determining one or more possible discounts that result in a monetary rate that satisfies the threshold; and
sending the one or more possible discounts in the message to the vendor, wherein the one or more possible discounts for the follow-up task are determined based on the rate difference.

9. The method of claim 8, further comprising:
receiving a selection of a first possible discount from the one or more possible discounts; and
sending an appointment invitation to an account of the customer, the appointment invitation including the first possible discount.

10. The method of claim 1, further comprising:
identifying a plurality of follow-up tasks having a rate difference greater than the threshold, wherein the message includes the plurality of follow-up tasks ranked by the rate difference.

11. The method of claim 1, wherein the message is sent from the computer system to a mobile device of the vendor.

12. The method of claim 1, wherein at least one of the plurality of follow-up tasks includes a plurality of actions.

13. The method of claim 1, further comprising:
selecting a new previous anchor location and a new subsequent anchor location; and
repeating the determination.

14. The method of claim 1, wherein at least one of the previous and subsequent anchor locations corresponds to an appointment for a job in a job table of the database or corresponds to a home address of the vendor.

15. The method of claim 1, further comprising:
displaying to the vendor a schedule of jobs for a current day;
retrieving one or more keywords corresponding to a first job in the schedule of jobs;
accessing a database table using the one or more keywords to identify one or more tools needed for the first job; and
displaying the one or more tools and materials needed for the first job.

16. The method of claim 1, wherein identifying the follow-up task that is associated with the completed job includes:
querying, by the computer system, a database using one or more keywords from the completed job, the method further comprising:
prompting the vendor whether to add the follow-up task to the follow-up table; and
storing the follow-up task in the follow-up record in the follow-up table based on a response from the vendor.

17. The method of claim 16, wherein the completed job includes installation of a new apparatus, when the one or more keywords includes product information of the new apparatus.

18. The method of claim 1, further comprising:
tracking no-shows and cancellations of appointments associated with jobs in a jobs table of the database;
computing a dependability score for each of the jobs based on no-shows and cancellations.

19. The method of claim 1, further comprising:
tracking an arrival time of the vendor at the locations of the jobs;
comparing the arrival times to corresponding appointment times of the jobs; and
computing an on-time score based on the comparison.

20. The method of claim 19, wherein computing the on-time score includes:
obtaining a weight for each of the appointment times of the jobs, where the weight of first appointment time is different than a weight the second appointment time, wherein a larger weight causes a larger change in the on-time score than a smaller weight.

21. The method of claim 20, further comprising:
identifying a traffic incident in a travel path of the vendor to a first location of a first job;
decreasing a weight corresponding to the first job, wherein the traffic incident results in a longer travel time relative to an expected travel time.

22. The method of claim 1, further comprising:
marking a first job as completed by:
determining that the vendor has departed from the first location;
prompting, at a mobile device, the vendor as to whether the first job is completed.

23. The method of claim 22, wherein the notification is sent when the mobile device of the vendor crosses a geo-fence around the first location.

24. The method of claim 1, wherein the message for a first follow-up task is provided in a follow-up task page that includes a contact object, wherein a communication is initiated with the customer for the first follow-up task in response to activating the contact object.

25. A computer product comprising a computer readable medium storing a plurality of instructions for controlling a processor to perform an operation of a method, the method comprising:
receiving, from a vendor, an indication that a job has been completed for a customer at a customer address, wherein the customer is stored as a customer record in a main table of a database;
identifying a follow-up task that is associated with the completed job;
storing a follow-up record for the follow-up task in a follow-up table in the database that is associated with the vendor, the follow-up table including a plurality of follow-up tasks associated with a plurality of completed jobs;
in response to a trigger, identifying a previous anchor location and a subsequent anchor location;
for each of a plurality of follow-up tasks in the follow-up table:
accessing the follow-up table to obtain:
the customer address for the follow-up task, and
a task duration of the follow-up task;
determining a first travel time between the previous anchor location and the customer address of the follow-up task;
determining a second travel time between the customer address of the follow-up task and the subsequent anchor location;
determining a total time for the follow-up task from the first travel time, the task duration, and the second travel time;
computing a metric using the total time;
providing the follow-up task in a message to the vendor when the metric is greater than a threshold.
